(19) United States
(12) Patent Application Publication
(10) Pub. No.: US 2002/0162840 A1
(43) Pub. Date: Nov. 7, 2002

(54) Compost box lid

(76) Inventor: Jean-Pierre Tschudi, Jens (CH)

Correspondence Address: DARBY & DARBY P.C., 805 Third Avenue, New York, NY, 10022, US

(21) Appl. No.: 10/087,438

(22) Filed: Feb. 21, 2002

Related U.S. Application Data
(63) Continuation of application No. PCT/CH01/00391, filed on Jun. 23, 2001.

(30) Foreign Application Priority Data
Jun. 25, 2000 (CH) 1288/00

(51) Int. Cl. B65D 43/26; B65F 1/00

(52) U.S. Cl. 220/263; 220/826; 220/909

(57) ABSTRACT

A lid construction having lid flaps (7, 8) is proposed for compost boxes (1, 2) which are serviced by shovel loaders, said lid construction ensuring improved hygiene for the environment due to a peripheral seal (9, 10), and re-supplying the condensate to its place of origin as a result of a structured cover-layer material (20) having ridge-like elevations (22, 23) with a grid structure on the ceiling of the semi-permeable tarpaulin, and thus improving the humidity retention and the quality of the compost.

### FIELD OF THE INVENTION

The invention relates to the lid for compost boxes.

### BACKGROUND OF THE INVENTION

The formation of humus is a procedure involving the mineralisation and humification of dead vegetable and animal substances by creatures in the soil and microorganisms, which produce the natural soil by the gradual decomposition of these substances. In nature, this process, which is also called rotting, lasts 1-2 years. If the biological degradation and conversion of solid organic substances is a planned process effected under the influence of aerobic microorganisms, then it is known as composting. Within several months, this produces a dark crumbly mass from waste materials, called compost.

Waste materials are substances which accumulate within the home, workplace, industry and agriculture and which are discarded because they are no longer deemed useful.

Thanks to the preparation of compost, the abundance of nutrient salts (phosphates, nitrogen and calcium compounds and humic substances) in waste materials is reused and converted into a valuable plant-nutrient medium. With an adequate air supply and sufficient moisture, the composting process proceeds in odourless manner, which modern technology claims to control with industrially monitored and enforced process management, even within the vicinity of a populated area. With this type or processing, it is possible to prepare the waste by ridding it of non-biologically degradable impurities, in particular plastics materials, and enabling a rotting grade of III-IV to be achieved in 7 weeks with aerated intensive rotting and secondary rotting. The compost then undergoes after-treatment, i.e. after sifting, air classification, re-screening and magnetic separation of the ferrous metals, it is discharged for use or, in order to satisfy more stringent requirements, it is kept in the compost plant for 4-5 weeks of subsequent maturation.

In order to ensure the air supply, the compost material is covered and aerated at an overpressure of approximately 100-200 Pa. Since shovel loaders are provided for accumulating, piling and removing the compost material, and, in recent times, the compost material is enclosed and covered at the touch of a button, the compost boxes used may be opened and closed by means of tarpaulins, have solid bases and walls and compartment over which a boom may pass (DE 296 16 788 U1), and clamping devices on the walls for securing the tarpaulin, or, in the case of a four-cornered plan and a preferably row-wise arrangement, openable front sides and covered lid flaps which may be swung open by means of lifting devices.

The lid flaps comprise two lid-flap frames, whereof the tarpaulins are breathable semi-permeable tarpaulins and form a gable-type lid when closed. The tarpaulins protect the compost material from the weather, and also from excess drying out, and at the same time enable the carbon dioxide CO₂ generated during composting to escape. Since, at high humidity, the air becomes saturated at relatively high temperatures and the surface temperature of the tarpaulin is the same as, or close to, that of the external air, many vapour molecules reach the dew point and liquefy on the cooling membrane surface to form condensate. So that the drops of condensate do not run to the hinge edge of the lid-flap frame, but rain down in somewhat dispersed manner, the inner surface of the covered lid flap is divided by axially-parallel drip lugs, along the lower edge of which the dripping procedure is effected.

The document DE 296 16 788 U1 (p. 8, para. 3) discloses that the cover is not—or not entirely—air-tight. Complaints from disappointed operators and those living within the vicinity of compost-box plants have shown that the production of compost is always linked to emissions which have an adverse physical and psychological effect on the operating personnel and the people within the surrounding area. The most recent results obtained from research (c. f. Kompost Magazin [Compost Magazine] 1999, p. 11, www.kompost.ch) show that the inhalation of compost aerosols is explicitly pathogenic.

In addition to the admitted leaks, the reason for this considerable disadvantage with compost boxes of both older and newer constructions is that, in operation, a buoyancy (˜200 N/m²) is generated by the inner pressure (˜200 Pa), said buoyancy corresponding approximately to the own weight of the lid construction, so that the static condition of the lid flaps is unstable and therefore the lid of the compost box is not properly closed. Due to these instabilities, the ventilation of the compost box is not controlled and the compost material therefore loses a greater amount of moisture. Since the moisture, which condenses on the ceiling, is recirculated on the way to the drip lugs, the moisture of the compost material is successively redistributed. With time, and a localised drying out of the liquid film of the compost material, the consequence of this redistribution is dire because the lack of moisture causes a loss of the natural filter effect which was previously capable of binding dust, odorous substances and other particles, such as bacteria, fungi and viruses. Thus, the deficiencies in existing compost boxes result in a self-generating threat of potentially harmful emissions which, as the community is also aware, pose a valid health risk.

The object of the invention below is to prevent these disadvantages. To achieve this object, a new lid construction for the mechanical servicing of the compost box is proposed, said lid construction preventing the uncontrolled discharge of aerosols and at the same time recycling the condensate on the lid uniformly over the entire under-lying area of the compost box.

According to the invention, in the case of four-cornered compost boxes of the above type, this is achieved by the peripheral seal of the lid edge and by a permanent closing force, which counteracts the inner pressure, and by the lid on the lid frame being formed by preferably uniform panels whereof the surface comprises a semi-permeable layer material which is breathable and has ridge-type elevations on its ceiling side, which preferably has a grid-like structure favourable for the local formation and dispersion of the condensate.

As a result of the controlled leak-tightness and the uniformly distributed resupply of the condensate, the compost-box lid according to the invention is as environmentally hygienic as possible and increases the quality of the compost. By means of the actuating device for the lid flaps, the lid can not only swing open, but also closed, and with so much force that the leak-tightness of the lid remains ensured even at a higher operating pressure and with a wind force of 4 on the Beaufort scale (which corresponds to a wind speed of 5.5 to 7.9 m/s). By using lid panels, the strength of the lid flaps is increased, the cost of on-site assembly is considerably reduced and, as a result of the possibility of carrying out repairs on-site, the maintenance of the lid flaps is facilitated. Since the components of the lid panel are simple to manufacture, require less storage space, and can be produced and serviced in a purely mechanical process, the system has all the advantages of modern industrial technology and logistics.

### BRIEF DESCRIPTION OF THE DRAWING

An appropriate exemplary embodiment of the invention is described in detail below, with reference to the Figures, in which:

FIG. 1 shows a half view of two adjacent compost boxes having a closed and open door and lid, and the associated open and closed lid actuation;

FIG. 2 shows a view of the gable-type lid having rain protection and the lid panels, and also a cross-section of the peripheral lid seal and the broken-away elements of the lid frame;

FIG. 3 shows a cross-section of the lateral lid-frame profile and a lid panel according to the details shown in section in FIG. 2;

FIG. 4 shows the corner part of the lid panel according to the details shown in section in FIG. 3;

FIG. 5 shows a view of part of the semi-permeable layer material, and a sectional view thereof;

FIG. 6 shows the detail of the closed lid hinge having the peripheral seal of the lid of the hinge part;

FIG. 7 shows the detail of the open hinge lid having the peripheral seal of the lid of the hinge part.

### DETAILED DESCRIPTION OF THE PREFERRED EMBODIMENT

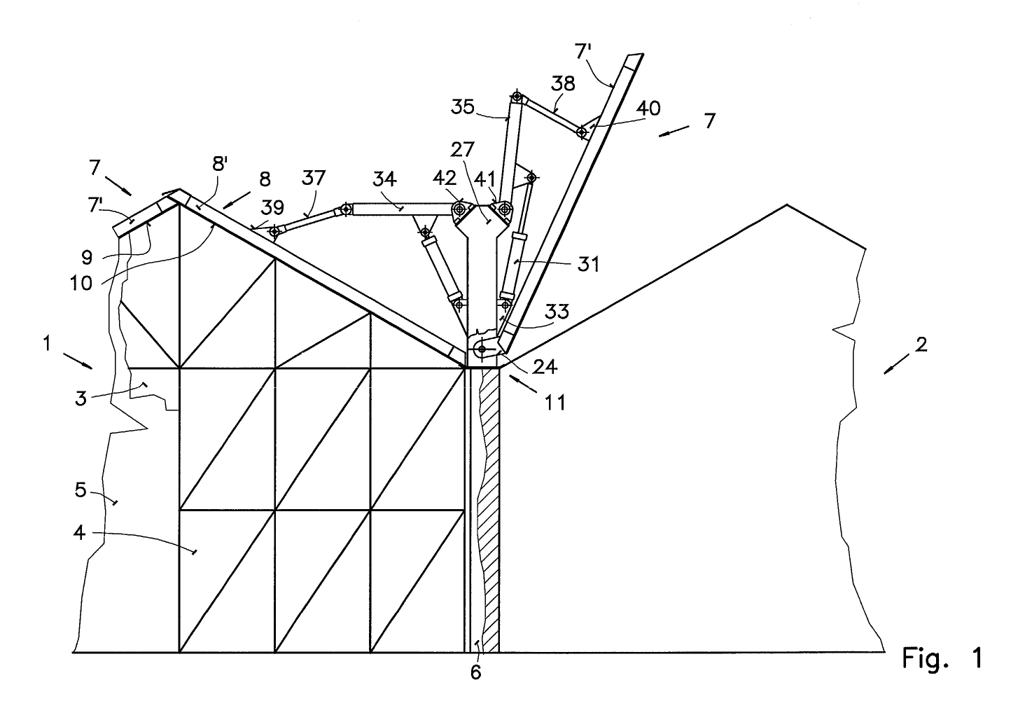

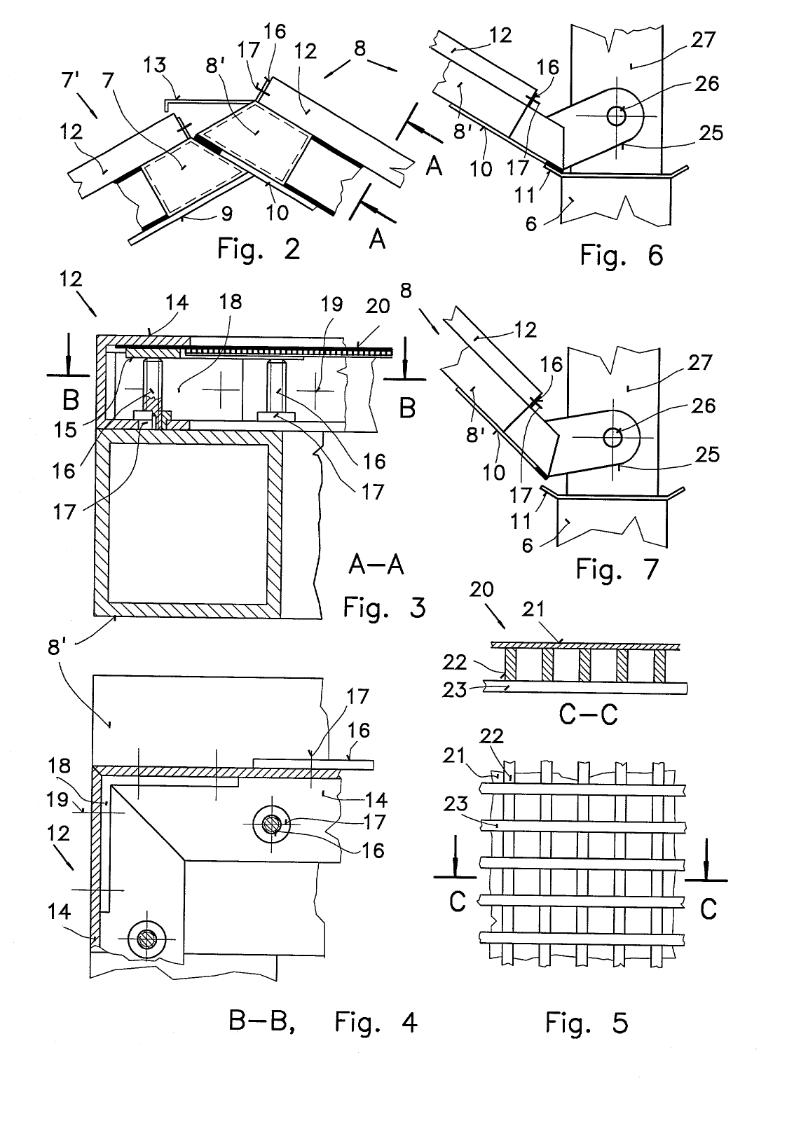

In FIG. 1, the view illustrates in each case half of the closed compost box having closed door flaps 3, 4, and the cut-off open compost box 2. The gable-type lid, which is shown enlarged in FIG. 2, is formed by the two mutually overlapping lid flaps 7, 8, of which the shorter lid flap 7 having the peripheral flat seal 9 is supported on the rear wall 5 and on the door flap 3, and, analogously with FIG. 6, on the top 11 of the partition wall 6. The longer lid flap 8 having the peripheral flat seal 10 is supported on the end face of the lid frame 7′ of the lid flap 7, on the upper edge of the door 4, the rear wall 5 and on the top 11 of the partition wall 6 (c. f. FIG. 6). The lid frames 7′, 8′ of the lid flaps 7, 8 are welded constructions and (as shown in FIGS. 1, 2, 3 and 6) are advantageously formed by trapezoidal and square hollow supporting profiles and serve to receive and support the lid panels 12 (c. f. 2, 3, 4, 6, 7). As shown in FIG. 2, the front side of the longer, overlapping lid flap 8 can be provided with a metal plate 13 for protection against the weather, which extends over the edge of the lid panels 12. To plank the lid frames 7′, 8′, lid panels 12 are provided, which are placed next to one another in a row and serve as removable frames for inserting and exchanging the breathable cover-layer material 20. As shown in FIGS. 3 and 4, they each advantageously comprise a U-profile frame 14 having a mitre cut and a right-angled corner connection 18, which may optionally be connected by releasable or non-releasable connecting elements 19, such as screws or blind rivets. For fixing the cover-layer material 20 in sealed manner in the lid panel 12, flat profiles 15 and grub screws 16 having a hexagon socket and inset nuts 17 are provided, which can be inserted into bores in the U-profile frame 14 for servicing and positioning purposes.

According to FIG. 5, the cover-layer material 20 comprises a breathable semi-permeable tarpaulin 21, and, on its ceiling side, preferably pasted-on ridge-type elevations 22, 23 of approximately 1 mm in width and approximately 2 mm in depth, which are arranged in horizontal and vertical rows and are connected together to form a grid-like structure and a 5.0 mm mesh. To seal the gaps and joins between the lid frames 7′, 8′ and the lid panels 12 and also the gaps and joins of the lid panel 12, proven means used in metal construction, such as silicone based filling pastes and adhesive strips, are suitable.

As shown in FIGS. 2 to 7, clips 16 and screws 17 on the lid frames 7′, 8′ serve to secure the lid panel 12.

On their side facing the partition wall 6, the lid flaps 7, 8 are pivotally connected to supporting clips 24 (c. f. FIG. 1) and supporting clips 25 (c. f. FIGS. 6, 7) in the manner of an angle lever by means of a bolt 26 of the supporting column 27. Owing to this arrangement, according to FIGS. 6 and 7 the peripheral flat seal 10 is lifted away from the top 1 1 of the partition wall 6 upon the pivotal movement of the lid flap 8 and, upon being lowered again, is compressed in sealing manner with negligible deformation. So that the shovel loaders can fill the compost box 1, 2 with the compost material in unimpeded manner almost up to the closed lid flaps 7, 8, according to FIG. 1 the lid flap 7 is swung upwards by means of the hydraulic cylinder 31. Here, the cylinder 31 is supported on the supporting column 27 by means of the bearing block 33, said supporting column being situated and anchored on the partition wall 6, and aligns the angle lever 35 held in the bearing 41 on the supporting column 27 approximately vertically, so that the folding arm 38, which is mounted in the bearing block 40 of the lid flap 7, draws up the lid flap 7.

Since the hydraulic cylinders 30 and 31 are double-acting, the hydraulic cylinder 30 secured to the supporting column 27 on the bearing block 32 can also retract, so that the angle lever 34 held in the bearing 42 on the supporting column 27 is drawn into the horizontal position and thus the lid flap 8, which may be pivoted about the bolt 26 (c. f. FIG. 6) is pressed against the lid flap 7, the door flap 4, the rear wall 5 and the top 11 of the wall by means of the folding arm 37 (which is secured in the bearing block 39), such that the peripheral flat seal 10 secured at the lower edge of the lid flap 8 is compressed in sealing manner.

What is claimed is:

1. A lid for enclosing and covering compost in boxes (1, 2) in the form of a bridge-like cover, which rests on a rear wall (5), a partition wall (6), and box-door flaps (3, 4) and preferably comprises lid flaps (7, 8) which can be swung open and closed and comprise at least one lid frame (7′, 8′), a covering layer of breathable tarpaulin (21) and an actuating means, characterised in that the lid frame (7′, 8′) has a preferably peripheral seal (9, 10) and the actuating means (24 to 42) is constructed such that it optionally serves to open the lid flaps (7, 8) or close them in sealed manner.

2. A lid according to claim 1 comprising at least one lid frame (7′, 8′), characterised in that the lid frame (7′, 8′) serves to receive lid panels (12).

3. A lid according to claims 1 and 2 characterised in that the lid panel (12) is constructed as a removable frame and preferably comprises a U-profile frame (14).

4. A lid according to claims 1 to 3, characterised in that the lid panels (12) support a breathable, semi-permeable tarpaulin (21), which is provided on its ceiling side with ridge-type elevations (22, 23), and in that the elevations (22, 23), which are preferably arranged in vertical and horizontal rows, are connected together to form grid-like structures.

5. A lid according to claims 1 and 2, characterised in that the closed lid flap (7, 8) is pressed by a permanent force acting in opposition to the inner pressure of the compost box (1, 2).

6. A lid according to claims 1, 2 and 5, characterised in that preferably double-acting hydraulic cylinders (30, 31) serve to actuate the lid flaps (7, 8).

7. A lid according to claims 1 and 2 and also 5 to 7 [sic], characterised in that the lid frames (7′, 8′) are connected in articulated manner to the supporting column (27) and the folding arms (37, 38) and also the angle levers (34, 35).

8. A lid according to claims 1 and 2 and also 5 and 6, characterised in that the hydraulic cylinders (30, 31) are connected to bearing blocks (32, 33) on the supporting column (27) and to articulated joints on the angle levers (34, 35).

9. A lid according to claims 1 and 2 and also 5 to 7, characterised in that an angle lever having supporting clips (24, 25) is formed at the end of the lid frame (7′, 8′), and the supporting clips (24, 25) are connected in hinge-like manner to the supporting column (27) by means of the bolt (26).

10. A lid according to claims 1 and 2 and also 5 to 7, characterised in that the supporting column (27) stands on the top (11) of the partition wall (6), and the top (11) of the wall serves as a contact face for the peripheral flat seal (9, 19) of the lid flap (7, 8).
